(19) United States
(12) Patent Application Publication
(10) Pub. No.: US 2024/0113397 A1
(43) Pub. Date: Apr. 4, 2024

(54) Busbar assembly, vehicle battery, and method for producing a busbar assembly

(71) Applicant: Webasto SE, Stockdorf (DE)

(72) Inventors: Moritz Pradella, Stockdorf (DE); Matthias Morvilius, Stockdorf (DE)

(21) Appl. No.: 18/371,760

(22) Filed: Sep. 22, 2023

(30) Foreign Application Priority Data
Sep. 30, 2022 (DE) 102022125430.5

(51) Int. Cl. H01M 50/507; B60L 50/64; H01M 50/204; H01M 50/249

(52) U.S. Cl. CPC H01M 50/507; B60L 50/64; H01M 50/204; H01M 50/249; H01M 2220/20

(57) ABSTRACT

A vehicle battery for an electric vehicle, a method for producing a busbar assembly, and a busbar assembly for installation in a vehicle battery for an electric vehicle, comprising a housing and a plurality of busbars received in the housing, where a busbar receiving body formed of a cured plastics foam is applied by foaming to an inside wall of a housing part, where each busbar is inserted into a receiver in the busbar receiving body and is held therein.

### CROSS-REFERENCE TO RELATED APPLICATION

This application claims priority to German Application No. DE 10 2022 125 430.5 filed Sep. 30, 2022, which is incorporated herein by reference in its entirety for all purposes.

### TECHNICAL FIELD

The present invention relates to a busbar assembly for installation in a vehicle battery in an electric vehicle, further to a vehicle battery for an electric vehicle, and to a method for producing a busbar assembly for installation in a vehicle battery in an electric vehicle.

### BACKGROUND

In the field of vehicle batteries in electric vehicles, it is known to electrically contact or connect the battery cells and battery modules with one another by means of collecting conductors, which are referred to synonymously as busbars. The busbars can be in the form of rigid current conductors of readily conductive metal, often copper or aluminium, more specifically of sheet metal strips, for example of copper. Because readily conductive metals such as copper are comparatively expensive, attempts are made to use them sparingly. Efforts are thus made, for example, to keep the cross section of the busbars used as small as possible. One criterion which stands in the way of a reduction in the cross section, more so than the electrical carrying capacity, is the development of heat in the busbars. This is because the better the dissipation of the heat that forms by friction of the electrons as the current flows, the smaller the cross section of the busbar can become. Moreover, as the temperature of the busbar increases, its ohmic resistance increases, which is to be avoided for reasons of efficiency.

As part of the requirement specification of a vehicle battery, a temperature limit of below 100° C., typically about 80° C., is often given as a requirement. This temperature limit must not be exceeded during operation.

For protection against inadvertent contacting of the busbars during mounting or maintenance, and in order to shield the busbars, with the exception of the contacting regions of the busbars that are provided for contacting, with respect to the surroundings, the busbars can be received in a half-shell or two-sided busbar housing.

In order to efficiently dissipate the heat that forms as a result of the current flow in the busbar, it is known to provide so-called gap pads, for example in the form of small EPDM mats or made of silicone, and/or so-called gap fillers, for example in the form of a gel-like paste which can possibly harden at least in part, which partially serve as a thermal bridge between the busbars and the housing. In order to ensure contact, or a planar connection, between the busbars, the gap filler or gap pad and the housing, hold-down devices, typically plastics hold-down devices, are further used.

### SUMMARY OF THE INVENTION

Starting from the known prior art, an object of the present invention is to provide an improved busbar assembly for installation in a vehicle battery for an electric vehicle, an improved vehicle battery, and a method for producing a busbar assembly.

The object is achieved by a busbar assembly for installation in a vehicle battery for an electric vehicle having the features of Claim 1. Advantageous developments will become apparent from the dependent claims, the description and the figures.

Accordingly, a busbar assembly for installation in a vehicle battery for an electric vehicle is proposed, which busbar assembly comprises a housing, more specifically a busbar housing for housing busbars, and a plurality of busbars received in the housing, wherein a busbar receiving body formed of a cured plastics foam is applied by foaming to an inside wall of a housing part, in particular to an inside wall of a lower shell and/or to an inside wall of an upper shell, wherein each busbar is inserted into a receiver in the previously cured busbar receiving body and is held therein.

Compared to conventional vehicle batteries, in which the busbars are held loosely or only at a point, the development of vibrations in the busbars can be substantially reduced or even avoided completely by means of the busbar receiving body. This is because the plastics foam has a damping effect. Moreover, the wall thickness of the busbar receiving body, or of the components thereof, can be varied in order to achieve vibration damping that is improved even further.

Furthermore, a comparatively large amount of heat can be dissipated by way of the busbar receiving body from the busbars held therein, in particular if the busbar receiving body extends substantially over the entire length of the busbars, optionally with the exception of the contact regions of the busbars. Inter alia, a comparatively large contact surface is provided between the busbars and the busbar receiving body. Moreover, the thermal conductivity of the plastics foam is higher by a multiple, for example by a factor of 20 in the case of polyurethane, than is the case with air.

Consequently, compared to conventional designs, smaller cross sections of the busbars can be used because, by means of the busbar receiving body, the thermally conductive contact surface is increased and the heat transfer capability is comparatively high.

Furthermore, the busbar assembly and a vehicle battery comprising the busbar assembly can be configured with fewer components compared to conventional designs. Inter alia, owing to the provision of the busbar receiving body, gap pads, gap fillers and hold-down devices, including the fastening screws required therefor, can be dispensed with.

Reducing the number of parts and therefore the number of manufacturing steps required to produce the busbar assembly or the vehicle battery further results in a reduction in the line cycle time in the production of a vehicle battery.

Owing to the good electrical insulating action of the plastics foam, it is possible, with a suitable design of the busbar receiving body or of the plurality of busbar receiving bodies, to achieve a further reduction in the installation space by reducing the minimum distances between adjacent busbars, without the risk of arcing being increased or even existing at all.

The term “apply by foaming” and “applied by foaming”, respectively, is here defined as the adhesion of the reactive foam material to the surface of an adhesive partner which occurs during a process of foaming a plastics foam. Accordingly, in a foaming process for forming the busbar receiving body, the foam is here permanently adhesively bonded to the inside wall as a result of the adhesive action of the reactive foam during foaming, specifically without an adhesive bonding step with an additional adhesive being carried out. There is thus no additional layer between the foam material of the busbar receiving body and the inside wall. Rather, the busbar receiving body adheres directly to the inside wall.

The receivers can be formed in each case between two adjacent ribs extending in a longitudinal extent of the busbar receiving body, wherein the ribs extend in particular transverse to the longitudinal extent from a base, arranged on the inside wall, of the busbar receiving body away from the base in a vertical direction. In other words, the busbar receiving body, when seen in a sectional view orthogonal to the longitudinal extent, can have a comb-like cross-sectional shape, wherein the ribs constitute the teeth, or synonymously the tines, of the comb.

The ribs can have a free end opposite the base, wherein in particular the free end of at least one rib is formed in a tapered fashion in the vertical direction, wherein, for example, at least one free end has at least one chamfer and/or at least one rounded region.

At least one of the ribs can have at its free end opposite the base an insertion chamfer for insertion of a busbar into a receiver. Mounting or insertion of the busbar into the receiver can be facilitated by the insertion chamfer. In particular, the insertion movement can then be performed less precisely and/or more quickly and/or with a higher insertion force than in the case of designs without an insertion chamfer, in which case it is necessary to work with greater precision.

The plastics foam of the busbar receiving body can comprise polyurethane.

A width of the receivers can be configured to be smaller by a predefined amount than a width of the busbar received in the respective receiver. A clamping action on the busbar can thus be achieved, so that the busbar is held fixedly in the receiver and is secured against slipping.

The housing can comprise an upper shell having a busbar receiving body and a lower shell having a busbar receiving body, wherein the ribs of the busbar receiving body of the upper shell are in contact with opposing ribs of the busbar receiving body of the lower shell at the free ends thereof, wherein preferably at least one pair of mutually opposite ribs forms a tongue-and-groove connection.

At least one of the ribs can be in the form of a rib that is continuous in the longitudinal extent and/or at least one of the ribs can be in the form of a rib that is segmented in the longitudinal extent, wherein in particular at least two adjacent ribs forming a receiver are segmented ribs, wherein the two segmented ribs, more specifically the segments thereof, are preferably arranged at least in part in an alternating manner in the longitudinal extent, wherein the two segmented ribs, more specifically the segments thereof, are preferably at a distance from one another, adjoin one another directly or have an overlapping region in the longitudinal extent.

The busbar receiving body can have at least one insert, preferably an insert in the form of a fastening point.

The above-mentioned object is further achieved by a vehicle battery for an electric vehicle having the features of Claim 11. Advantageous developments will become apparent from the present description and the figures.

Accordingly, a vehicle battery for an electric vehicle is proposed, which vehicle battery comprises a plurality of battery units which are to be connected together, in particular a plurality of battery modules each comprising multiple battery cells, and a busbar assembly according to one of the preceding embodiments. The battery units can be electrically contacted by the busbars of the busbar assembly.

The advantages and effects described in respect of the busbar assembly are achieved in an analogous manner by means of the vehicle battery.

A “vehicle battery for an electric vehicle” is here understood as being the primary drive battery of the electric vehicle, that is to say the battery that provides the (high-voltage) power for the electric motor, configured as the primary traction drive, of the electric vehicle.

The object set out above is further achieved by a method for producing a busbar assembly for installation in a vehicle battery of an electric vehicle having the features of Claim 12. Advantageous developments of the method will become apparent from the present description and the figures.

Accordingly, a method for producing a busbar assembly for installation in a vehicle battery of an electric vehicle is proposed, which method comprises inserting a housing part, in particular an upper shell and/or a lower shell, of a housing into a foaming tool, filling a mould present in the closed foaming tool with foam by introducing a curable foam material in order to form a plastics foam, such that the foam material enters into a permanent adhesive bond with an inside wall of the housing part during foaming, curing the plastics material so that a composite body consisting of the housing part and a busbar receiving body formed of the cured plastics foam and applied by foaming to the inside wall of the housing part is formed, demoulding the composite body from the housing part and the busbar receiving body applied by foaming to the inside wall of the housing part, and inserting a plurality of busbars into receivers provided in the cured busbar receiving body.

### BRIEF DESCRIPTION OF THE FIGURES

Preferred further embodiments of the invention will be explained in greater detail by the following description of the figures, in which:

FIG. 1 shows, schematically, a perspective sectional view through a busbar assembly for a vehicle battery in an electric vehicle;

FIG. 2 shows, schematically, a sectional view through the busbar assembly of FIG. 1 orthogonal to a longitudinal extent of the busbar assembly;

FIG. 3 shows, schematically, a sectional view through a busbar assembly according to a further embodiment orthogonal to a longitudinal extent of the busbar assembly;

FIG. 4 shows, schematically, a sectional view through a busbar assembly according to a further embodiment orthogonal to a longitudinal extent of the busbar assembly; and

FIG. 5 shows, schematically, a plan view in the vertical direction of a busbar assembly according to a further embodiment.

### DETAILED DESCRIPTION OF PREFERRED EXEMPLARY EMBODIMENTS

In the following text, preferred exemplary embodiments are described with reference to the figures. Elements in the various figures which are the same, similar or have the same effect are provided with identical reference signs, and a repeat description of such elements is in some cases dispensed with, in order to avoid duplication.

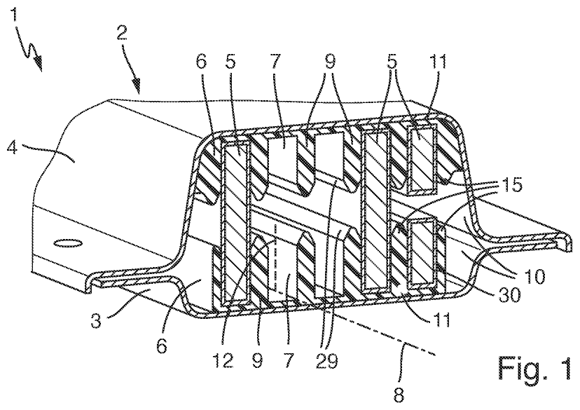

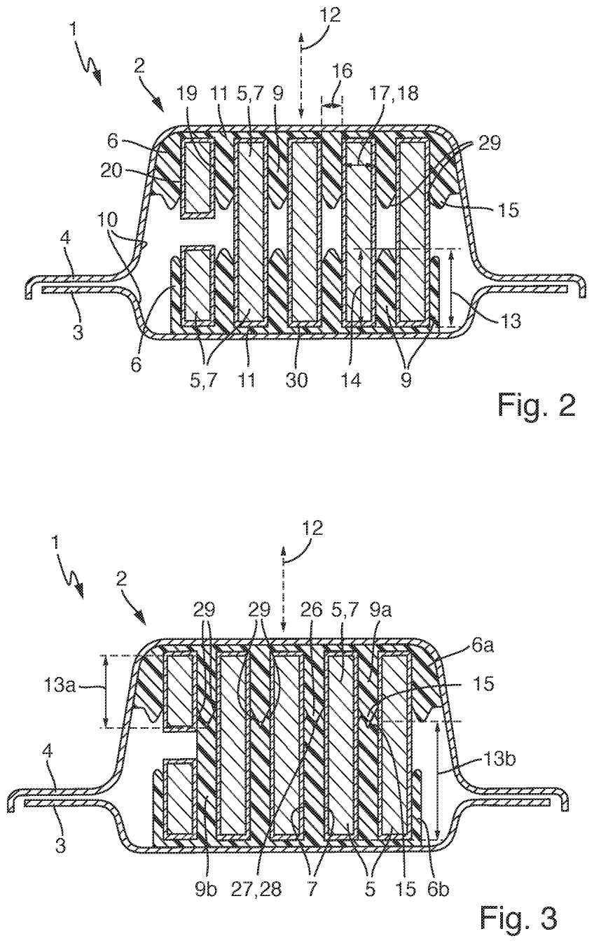

FIG. 1 shows, schematically, a perspective sectional view through a busbar assembly 1 for a vehicle battery in an electric vehicle. FIG. 2 shows the sectional view of FIG. 1 again, orthogonal to the sectional plane.

The busbar assembly 1 comprises a housing 2 having a lower shell 3 and an upper shell 4. A plurality of busbars 5 are accommodated inside the housing 2.

A busbar receiving body 6 formed of a plastics foam is applied by foaming to an inside wall 10 of the lower shell 3, that is to say is permanently adhesively bonded to the inside wall of the lower shell 3 in a foaming process for forming the busbar receiving body 6 as a result of the adhesive action of the reactive foam during foaming, without an adhesive bonding step using an additional adhesive being carried out.

The busbar receiving body 6 comprises a plurality of channel-like receivers 7 which extend in a longitudinal direction 8 and are to receive a busbar 5. The receivers 7 are each configured to receive a busbar 5. The longitudinal direction 8 corresponds to the longitudinal extent 8 of the busbar 5 to be received.

The receivers 5 are formed in the busbar receiving body 6 in each case between two adjacent ribs 9 extending in the longitudinal extent 8. The ribs 9 further extend transverse to their longitudinal extent 8 in a vertical direction 12 away from a base 11, arranged on the inside wall 10 of the lower shell 3, of the busbar receiving body 6 obliquely from the base 11 or transverse to the base 11, that is to say obliquely or transverse to the inside wall 10. They therefore have a predefined height 13. The receivers 7 correspondingly have a predefined depth 14, which is preferably determined substantially by the height 13 of the ribs 9.

The ribs 9 are formed in a tapered fashion in the vertical direction 12 at their free end 15 opposite the base 11. In other words, the width 16 of the ribs 9 decreases at the free end orthogonal to the longitudinal extent 8 and orthogonal to the vertical direction 12 as the distance from the base 11 increases. The free end 15 can have at least one chamfer and/or at least one rounded region. The tapered region of the ribs 9 accordingly forms an insertion chamfer 29, which allows the busbars 5 to be mounted more easily in the respective receiver 7.

In addition, the upper shell 4 of the housing 2, analogously to the lower shell 3, likewise comprises a busbar receiving body 6, formed of a plastics foam, which has been applied by foaming and which has the same features and properties as the busbar receiving body 6 of the lower shell 2, for which reason a repeat description of the busbar receiving body 6 of the upper shell 4 is dispensed with and reference is made to the above explanations.

According to this embodiment, the housing parts 3, 4 of the housing 2 are formed of an aluminium alloy, but they are not limited thereto.

According to this embodiment, the plastics foam of the busbar receiving body 6 comprises at least polyurethane (PU, synonymously also PUR). In other words, the busbar receiving body 6 is formed substantially of cured PU foam. However, it is not limited thereto, and other suitable foam materials may also be used.

The width 17 of the receivers 7 can be configured to be smaller by a predefined amount than the width 18 of the busbar 5 to be received in the respective receiver 7. The busbar 5 can thus be received in a clamped manner in the receiver 7. This is because the lateral walls 19 of the ribs 9 forming the receiver 7 exert a pressure on the lateral surfaces 20 of the busbar 5 held therein. In addition, particularly good heat conduction from the busbar 5 into the ribs 9 can thus be achieved. The lateral walls 19 of the ribs 9 are pressed against the lateral surfaces 20 of the busbar 5, so that planar contact between the two above-mentioned elements is achieved, that is to say there are no or only a small number of air pores, which could act in a thermally insulating manner, between the lateral wall 19 and the lateral surface 20.

In addition, by means of the planar adhesion of the base 11 to the inside wall 10, direct heat conduction between the busbar receiving body 6 and the housing 2 is provided over substantially the whole surface.

In the present case, the busbars 5 optionally comprise a touch-safe shield 30.

FIG. 3 shows a sectional view orthogonal to the longitudinal extent 8 of a busbar assembly 1 according to a further embodiment. This corresponds substantially to that of FIGS. 1 and 2, wherein the ribs 9a of the busbar receiving body 6a of the upper shell 4 and the ribs 9b of the busbar receiving body 6b of the lower shell 3 here each have a height 13a, 13b, so that in the assembled state, as shown in FIG. 3, they are in contact. The busbars 5, when seen in the vertical direction 12, are thus in contact substantially over their entire height with the foam body material of the busbar receiving bodies 6a, 6b. Accordingly, a particularly large surface is available for the dissipation of heat from the busbars 5 into the busbar holding bodies 6a, 6b, similar to surrounding the busbars 5 completely with foam. In addition, the busbars 5, when seen transverse to the longitudinal extent 8 and transverse to the vertical direction 12, can thus be encapsulated from one another. The risk of an arc forming between adjacent busbars 5 owing to the absence of an air gap between adjacent busbars 5 is accordingly reduced or even prevented completely. The busbars 5 can therefore be positioned particularly close to one another.

In order to achieve a particularly good sealing action, the free ends 15, in the form of tapering tongues or projections 26, of the ribs 9a of the busbar receiving body 6a of the upper shell 4 are configured such that they are in engagement with end receivers 27 at the free ends 15 of the ribs 9b of the busbar receiving body 6b of the lower shell 3, which end receivers are in the present case in the form of a groove 28 extending in the longitudinal extent 8 at the free end of the ribs 9b of the busbar receiving body 6b of the lower shell 3; they therefore form a tongue-and-groove connection. Accordingly, on assembly, the free ends 15, in the form of the projections 26, of the busbar receiving body 6a of the upper shell 4 are inserted into the grooves 28 provided at the free ends 15 of the busbar receiving body 6b of the lower shell 3 and brought into contact.

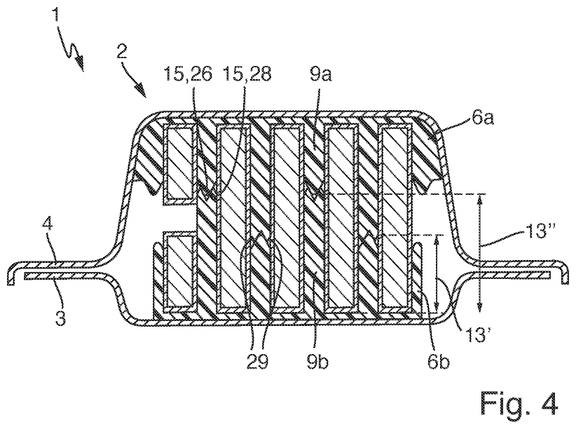

FIG. 4 shows a sectional view orthogonal to the longitudinal extent 8 of a busbar assembly 1 according to a further embodiment. This corresponds substantially to that of FIG. 3, wherein the ribs 9a, 9b of the two busbar holding bodies 6a, 6b do not all have the same height 13 but alternately have a first height 13′ and a second height 13″. In addition, the projections 26 and grooves 28 are provided alternately at the free ends 15.

As is apparent from FIGS. 3 and 4, each rib 9a, 9b additionally comprises the insertion chamfers 29.

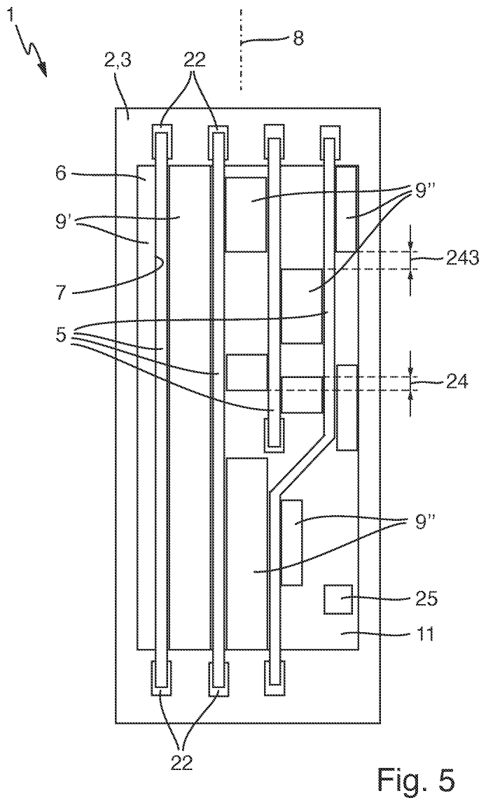

FIG. 5 shows a plan view in the vertical direction 12 of a busbar assembly 1 for a vehicle battery according to a further embodiment, which corresponds substantially to that of FIGS. 1 and 2.

The busbar assembly 1 comprises a housing 2 formed of a lower shell 3, to which there has been applied by foaming a busbar receiving body 6 formed of a cured plastics foam.

A busbar 5 is received and held in each of the receivers 7 of the busbar receiving body 6. The housing 2 and the busbar receiving body 6 have apertures 22 at the contact regions 21 of the busbars 5, at which the busbars are to be electrically contacted.

As is apparent from FIG. 5, some of the ribs 9′ are configured to be continuous in the longitudinal extent 8. The busbar receiving body 6 additionally comprises ribs 9″ that are of segmented form. In other words, these ribs 9″ are configured to be interrupted in the longitudinal extent 8. Preferably, the two segmented ribs 9″ forming a receiver 7, more specifically the segments thereof forming the segmented rib 9″, are arranged at least in part in an alternating manner in the longitudinal extent 8. The ribs 9″, more specifically the segments thereof, can be at a distance from one another, can adjoin one another directly or can have an overlapping region 24 in the longitudinal extent 8.

The busbar receiving body 6 can further have at least one insert 25. The insert 25 can be in the form of a fastening point for a component of the busbar assembly 1 and/or a further component of a vehicle battery having the busbar assembly 1. The insert 25 can be in form of a screw point, for example, and to that end can have a threaded pin or an internal thread.

The insert 25 can further comprise a sensor, preferably a temperature sensor, a humidity sensor or an acceleration sensor.

The insert 25 is surrounded at least partly by the cured foam material of the busbar receiving body 6; it is therefore received at least partly in the busbar receiving body 6.

In the following text, a method for producing a busbar assembly will be described in detail.

In a first step, an upper shell 4 and/or a lower shell 3 of the housing 2 is placed in a foaming tool, and the foaming tool is closed. The mould present in the foaming tool is then cast, that is to say the starting material of the plastics material, in the present case, without implying any limitation, polyurethane (PU), is foamed in. Owing to its very good adhesive properties, the foaming polyurethane composition adheres to the aluminium material of the housing 2 at the inside walls 10. Pre-treatment of the surfaces by means of cleaning and/or activation can optionally be carried out.

Accordingly, two composite bodies are formed, each of which is formed by a housing shell (upper shell 4 or lower shell 3) and the busbar receiving body 6 of the cured polyurethane applied by foaming to the inside wall 10.

Assembly of the busbar assembly 1 can be carried out either directly during assembly of the vehicle battery. In that case, the lower shell 3 provided with the busbar receiving body 6 applied by foaming is first placed into the vehicle battery and possibly pre-positioned or positioned. The plurality of busbars 5 can then be inserted into the individual receivers 7 in the busbar receiving body 6 and optionally electrically and/or mechanically contacted with contacting points in the vehicle battery. Finally, the upper shell 4 can be attached. To this end, the busbar receiving body 6 of the upper shell 4 is fitted to the busbars 5 held in the busbar receiving body 6 of the lower shell 3 until the upper shell 4 is positioned as intended relative to the lower shell 3, or inside the vehicle battery.

Alternatively, assembly of the busbar assembly 1 can be carried out at least partially before the vehicle battery is actually assembled. In that case, the plurality of busbars 5 are placed in the busbar receiving body 6 of the lower shell 3 or of the upper shell 4 and the respective other shell 4, 3 of the housing 2 is fitted, and the housing shells 3, 4 are preferably connected together, for example screwed together, before the resulting assembly group as a whole is installed in the vehicle battery.

Where applicable, all the individual features which are shown in the exemplary embodiments can be combined and/or exchanged with one another without departing from the scope of the invention.

### LIST OF REFERENCE SIGNS

1 Busbar assembly
2 Housing
3 Lower shell
4 Upper shell
5 Busbar
6 Busbar receiving body
7 Receiver
8 Longitudinal extent
9 Rib
10 Inside wall
11 Base
12 Vertical direction
13 Height
14 Depth
15 Free end
16 Width of the rib
17 Width of the receiver
18 Width of the busbar
19 Lateral wall
20 Lateral surface
22 Aperture
25 Insert
26 Projection
27 End receiver
28 Groove
29 Insertion chamfer
30 Touch-safe shield

1. A busbar assembly for installation in a vehicle battery for an electric vehicle, comprising a housing and a plurality of busbars received in the housing, the busbar assembly comprising:
a busbar receiving body formed of a cured plastics foam configured by applying foaming to an inside wall of a housing part, wherein each busbar is inserted into a receiver in the busbar receiving body and is held therein.

2. The busbar assembly according to claim 1, wherein the receivers are formed in each case between two adjacent ribs extending in a longitudinal extent of the busbar receiving body, wherein the ribs further extend transverse to the longitudinal extent from a base, arranged on the inside wall, of the busbar receiving body away from the base in a vertical direction.

3. The busbar assembly (1) according to claim 2, wherein the ribs have a free end opposite the base.

4. The busbar assembly according to claim 3, wherein the free end of at least one rib is formed in a tapered fashion in the vertical direction, wherein at least one free end has at least one of: at least one chamfer and at least one rounded region.

5. The busbar assembly according to claim 3, wherein at least one of the ribs has at its free end opposite the base an insertion chamfer for insertion of a busbar into an associated receiver.

6. The busbar assembly according to claim 5, wherein the plastics foam of the busbar receiving body comprises polyurethane.

7. The busbar assembly according to claim 6, wherein a width of the receivers is configured to be smaller by a predefined amount than a width of the busbar received in the respective receiver.

8. The busbar assembly according to claim 7, wherein the housing comprises an upper shell having a busbar receiving body and a lower shell having a busbar receiving body, wherein the ribs of the busbar receiving body of the upper shell are in contact with opposing ribs of the busbar receiving body of the lower shell at the free ends thereof.

9. The busbar assembly according to claim 8, wherein at least one of the ribs is in the form of at least one of: a rib that is continuous in the longitudinal extent and a rib that is segmented in the longitudinal extent wherein the two segmented ribs are arranged at least in part in an alternating manner in the longitudinal extent, wherein the two segmented ribs (9″) are at least one of: at a distance to one another, adjoin one another directly, and have an overlapping region in the longitudinal extent.

10. The busbar assembly according to claim 9, wherein the busbar receiving body has at least one insert in the form of a fastening point.

11. A vehicle battery for an electric vehicle, comprising a plurality of battery units which are to be connected together, a plurality of battery modules each comprising multiple battery cells comprising a busbar assembly comprising: a housing and a plurality of busbars received in the housing, a busbar receiving body formed of a cured plastics foam configured by applying foaming to an inside wall of a housing part, wherein each busbar is inserted into a receiver in the busbar receiving body and is held therein.

12. A method for producing a busbar assembly for installation in a vehicle battery of an electric vehicle, comprising:
inserting a housing part of a housing into a foaming tool;
foam filling a mould present in the closed foaming tool with foam by introducing a curable foam material in order to form a plastics foam, such that the foam material enters into a permanent adhesive bond with an inside wall of the housing part during foaming;
curing the plastics material so that a composite body consisting of the housing part and a busbar receiving body formed of the cured plastics foam configured by applying foaming to the inside wall of the housing part is formed;
demoulding the composite body from the housing part and the busbar receiving body configured by applying foaming to the inside wall of the housing part; and
inserting a plurality of busbars into receivers provided in the cured busbar receiving body.

13. The method according to claim 12, wherein the housing part is at least one of: an upper shell and a lower shell.

14. The busbar assembly according to claim 1, wherein the cured plastics foam is configured by applying foaming to at least one of: an inside wall of a lower shell and an inside wall of an upper shell.

15. The busbar assembly according to claim 8, wherein at least one pair of opposite ribs forms a tongue-and-groove connection.

16. The busbar assembly according to claim 9, wherein at least two adjacent ribs forming a receiver are segmented ribs.
